(19) United States
(12) Patent Application Publication
(10) Pub. No.: US 2011/0115375 A1
(43) Pub. Date: May 19, 2011

(54) LIGHTING DEVICE FOR VEHICLE

(75) Inventors: Masanori SHIRATSUCHI, Kawasaki-shi (JP); Yoshitaka TANABE, Kawasaki-shi (JP); Youichi TAKANO, Kawasaki-shi (JP)

(73) Assignee: FALTEC CO., LTD., Kawasaki-shi (JP)

(21) Appl. No.: 12/947,035

(22) Filed: Nov. 16, 2010

(30) Foreign Application Priority Data
Nov. 18, 2009 (JP) 2009-262992

(51) Int. Cl. B60Q 1/14

(52) U.S. Cl. 315/77

(57) ABSTRACT

A lighting device for a vehicle includes a headlamp; a door lamp that illuminates the ground, an inner sill lamp that illuminates a cabin floor, a user position detector that detects whether a user is close to the vehicle or distant from the vehicle, a door open/close detector, and a controller. The controller turns on the headlamp when the user position detector detects a user's approach to the vehicle, turns on the door lamp when opening of the door is detected by the door open/close detector, and then turns on the inner sill lamp. According to the lighting device, the user can smoothly get in or off the vehicle at night.

### CROSS-REFERENCE TO RELATED APPLICATION

This application is based upon and claims the benefit of Japanese Patent Application No. 2009-262992, filed on Nov. 18, 2009; the entire contents of which are incorporated herein by reference for all purposes.

### BACKGROUND OF THE INVENTION

1. Field of the Invention

The present invention relates to a lighting device for a vehicle, and more particularly to a lighting device for illuminating when a driver gets in or gets off a vehicle.

2. Background Art

As a conventional lighting device for a vehicle, there has been known a lighting device disclosed in Japanese Patent Application Laid-Open No. 2001-97113. This lighting device includes a unit that detects whether a vehicle is in a stopped state or in a traveling state, cabin lamps provided in a cabin of the vehicle, and a controller, which controls illuminance of the cabin lamps. The controller performs a control such that each light emission of the cabin lamps is set high when the vehicle is in a stopped state, and each light emission of the cabin lamps is set slightly low when the vehicle is in a traveling state.

Due to such a control, a user (driver) can exclusively concentrate on driving during the vehicle travels, and can easily work in a cabin during the vehicle stops.

### SUMMARY OF THE INVENTION

However, in the above-mentioned conventional lighting device, behaviors of the user when getting in or off the vehicle at night are not taken into consideration.

Further, there has been known a lighting device for a vehicle in which a door lamp provided on a cabin inner surface of a door to illuminate when a door is opened. However, such a door lamp is not sufficient for a user to smoothly get in or off the vehicle. Accordingly, there as been desired a lighting device for a vehicle that enables a user to smoothly get in or off a vehicle.

It is an object of the present invention to provide a lighting device for a vehicle that enables a user to smoothly get in or off a vehicle at night.

A first aspect of the present invention provides a lighting device for a vehicle that includes a vehicle exterior lamp that illuminates an outside of the vehicle, a ground lamp that illuminates a ground on which a user stands when the user is going to open a door to get in the vehicle, a floor lamp that illuminates a cabin floor on which a user's foot is to be put when a user is going to get in the vehicle, a user position detector that detects whether the user is at a close position to the vehicle or a distant position from the vehicle, a door open/close detector that detects opening and closing of the door, and a controller. The controller turns on the vehicle exterior lamp when the user position detector detects a user's approach to the vehicle, turns on the ground lamp when opening of the door is detected by the door open/close detector, and then turns on the floor lamp.

According to the first aspect of the present invention, areas around the vehicle are illuminated by the vehicle exterior lamp upon detection of the user's approach to the vehicle by the user position detector. When the user opens the door, the ground on which the user stands at the time of getting in the vehicle is illuminated by the ground lamp. In addition, the floor of the cabin into which the user is going to get is illuminated by the floor lamp. Accordingly, the user can be supported to get in the vehicle by the lightings so that the user can smoothly get in the vehicle at night (a dark place).

It is preferable that the controller further turns on a foot lamp and a map lamp after turning on the floor lamp.

According to this configuration, the floor around the user's feet at the time of seating is illuminated by the foot lamp when the user gets in the vehicle, and the cabin into which the user gets is also illuminated by the map lamp. Accordingly, the user can get in the vehicle more smoothly.

It is preferable that the lighting device further includes a door lock detector that detects locking and unlocking of the door, and the controller turns off the vehicle exterior lamp when the door lock detector detects unlocking of the door.

According to this configuration, the vehicle exterior lamp is turned off when the user unlocks the door to get in the vehicle. Accordingly, it is possible to suppress wasteful power consumption.

It is preferable that the lighting device further includes an instrument lamp that illuminates a meter and a seating detector that detects seating of the user, and the controller turns on the instrument lamp when the seating detector detects seating of a driver.

According to this configuration, the instrument lamp is turn on when the user sits on a seat. Accordingly, operability for the user at night (a dark place) can be enhanced.

It is preferable that the controller turns off the ground lamp and the floor lamp when an ignition key is turned on.

According to this configuration, the ground lamp and the floor lamp are turned off when the user turns on an ignition key. Accordingly, it is possible to suppress wasteful power consumption.

A second aspect of the present invention provides a lighting device for a vehicle that includes a floor lamp that illuminates a cabin floor on which a user's foot is to be put when a user is going to get off the vehicle, a ground lamp that illuminates a ground on which the user is going to stand when the user opens a door to get off the vehicle, a vehicle exterior lamp that illuminates an outside of the vehicle, a door open/close detector that detects opening and closing of the door, and a controller. The controller sequentially turns on the floor lamp and the ground lamp when the door open/close detector detects opening of the door, and then turns on the vehicle exterior lamp.

According to the second aspect of the present invention, the floor on which the user's foot is put is illuminated by the floor lamp until the user gets off the vehicle when the user opens the door to get off the vehicle. In addition, the ground on which the user's foot is put is illuminated by the ground lamp when the user gets off the vehicle. Further, areas around the vehicle are illuminated by the vehicle exterior lamp when the user gets off the vehicle. Accordingly, the user can be supported to get off the vehicle by the lightings so that the user can smoothly get off the vehicle at night (a dark place).

It is preferable that the lighting device further includes an instrument lamp that illuminates a meter, and the controller turns off the instrument lamp when an ignition key is turned off, and then turns on a foot lamp and a map lamp.

According to this configuration, the instrument lamp is turned off when the user turns off an ignition key. Accordingly, it is possible to suppress wasteful power consumption.

It is preferable that the lighting device further includes a user position detector that detects whether the user is at a close position to the vehicle or a distant position from the vehicle and a door lock detector that detects locking and unlocking of the door, and the vehicle exterior lamp includes a headlamp and an door outside handle lamp, and the controller turns off the door outside handle lamp when the door lock detector detects locking of the door, and turns off the headlamp when the user position detector detects a user's departure from the vehicle.

According to this configuration, the door outside handle lamp is turned off when the user who gets off the vehicle locks the door. In addition, the headlamp is turned off when the user leaves the vehicle. Accordingly, it is possible to suppress wasteful power consumption.

### BRIEF DESCRIPTION OF THE DRAWINGS

FIG. 1A is a schematic perspective view of a vehicle showing lamps provided outside the vehicle according to an embodiment;

FIG. 1B is a perspective view of the vehicle showing lamps provided inside the vehicle;

FIG. 2A is a cross-sectional view indicating a position of an inner sill lamp and a position of a kick plate lamp when a door is closed;

FIG. 2B is a cross-sectional view indicating the position of the inner sill lamp and the position of the kick plate lamp when the door is opened;

FIG. 3 is a schematic block diagram of a control system of a lighting device for a vehicle according to the embodiment;

FIG. 4 is a flow chart of control processing taken when a user gets in the vehicle;

FIG. 5A is a part of a flow chart of control processing taken when the user gets off the vehicle;

FIG. 5B is another part of the flow chart of the control processing;

FIG. 6 is a flow chart of control processing taken when the user drives the vehicle;

FIG. 7 is a schematic plan view showing an illumination state of the vehicle when the user approaches the vehicle; and

FIG. 8 is a schematic plan view showing an illumination state of the vehicle when the user opens the door.

### DESCRIPTION OF THE PREFERRED EMBODIMENT

Hereinafter, a lighting device for a vehicle according to an embodiment is explained with reference to the drawings.

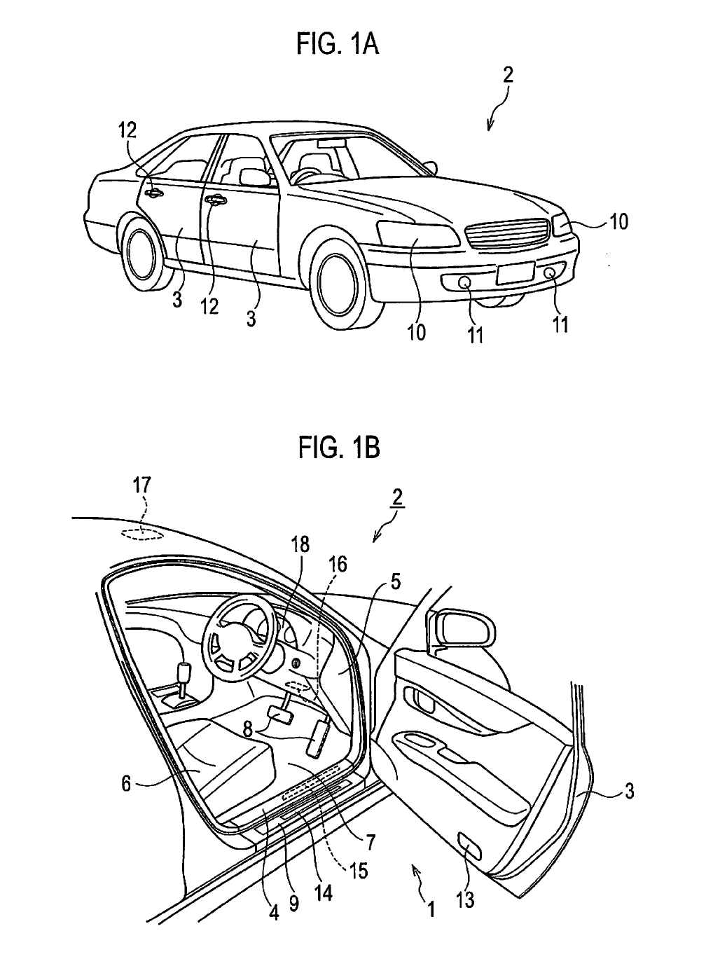

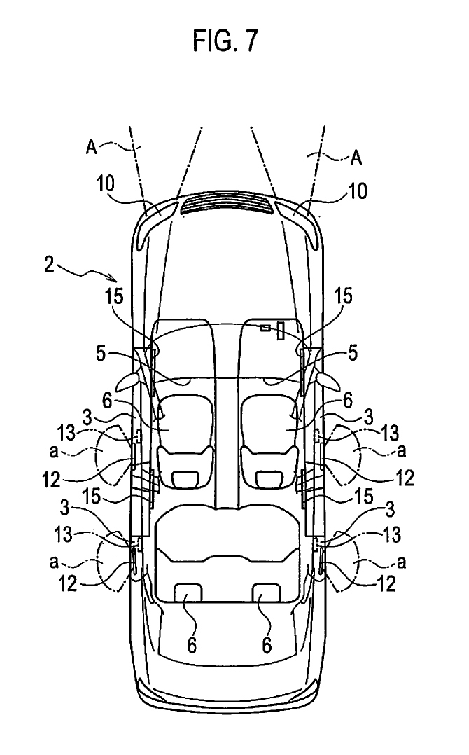

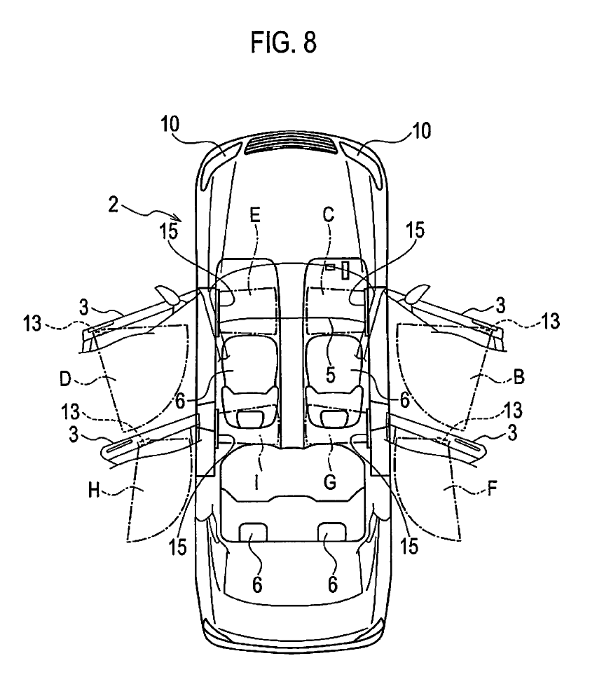

As shown in FIG. 1B, FIG. 7 and FIG. 8, four seats 6 are provided on a floor 7 inside a cabin of the vehicle 2. Two of the seats 6 are provided on a front side and remaining two of the seats 6 are provided on a rear side. An instrument panel 5 is provided in front of the driver's seat 6. Pedals B are provided on a floor in front of the driver's seat 6 and below the instrument panel 5.

Door openings are provided on sides of the vehicle 2 corresponding to the seats 6, respectively. The door openings are opened and closed by doors 3, respectively. Kick plates 9 are fixed to an outer body panel 9A below the door openings, respectively. Inner sill covers 4 are fixed at positions closest to cabin inner sides of the kick plates 9, respectively. Each of the inner sill covers 4 is arranged parallel to each of the kick plates 9. The inner sill covers 4 are located higher than the kick plates 9, respectively.

As shown in FIG. 1A and FIG. 7, the lighting device 1 includes plural vehicle exterior lamps which are provided outside the vehicle 2 and illuminate the outside of the vehicle 2. The vehicle exterior lamps are constituted of headlamps 10, fog lamps 11, door outside handle lamps 12 and the like. The headlamps 10 and the fog lamps 11 are arranged on both left and right sides at a front of the vehicle 2 and illuminate ahead of the vehicle 2 (illuminating ranges A shown in FIG. 7). The door outside handle lamps 12 are mounted on outside handles on the door 3, respectively. Each of the door outside handle lamps 12 irradiates light toward an area below the outside handle and illuminates the ground around the door 3 (illuminating ranges a in FIG. 7: each of the door outside handle lamp 12 also functions as a ground lamp).

As shown in FIG. 1B and FIG. 8, the lighting device 1 includes plural cabin lamps which are provided inside the vehicle 2 and basically illuminate the inside of the cabin of the vehicle 2. The cabin lamps are constituted of four door lamps (ground lamps) 13 provided on an inner surface of the doors 3, four kick plate lamps 14 embedded on upper surfaces of the kick plates 9, four inner sill lamps (floor lamps) 15 provided on an inner side of the inner sill covers 4, a foot lamp 16 provided under the instrument panel 5, four map lamps 17 provided on a ceiling of the cabin, an instrument lamp 18, and the like. The foot lamp 16 illuminates the floor 7 in front of the driver's seat 6 (i.e. an area around feet of the seating driver: an area around the pedals 8). The map lamps 17 illuminate cabin areas corresponding to the respective seats 6. The instrument lamp 18 illuminates meters.

Each of the door lamps 13 illuminates, in a state where each of the doors 3 is opened, the ground on which a user stands at the time of getting in the vehicle 2 or the ground on which the user stands at the time of getting off the vehicle 2 (illuminating a range B, D, F or H in FIG. 8).

Each of the kick plate lamps 14 irradiates light upward from an upper surface of each of the kick plates 9 (light irradiation ranges are not shown in FIG. 8). Accordingly, the kick plate lamps 14 allow the users to recognize lower end positions of the door openings when the users get in or off the vehicle 2.

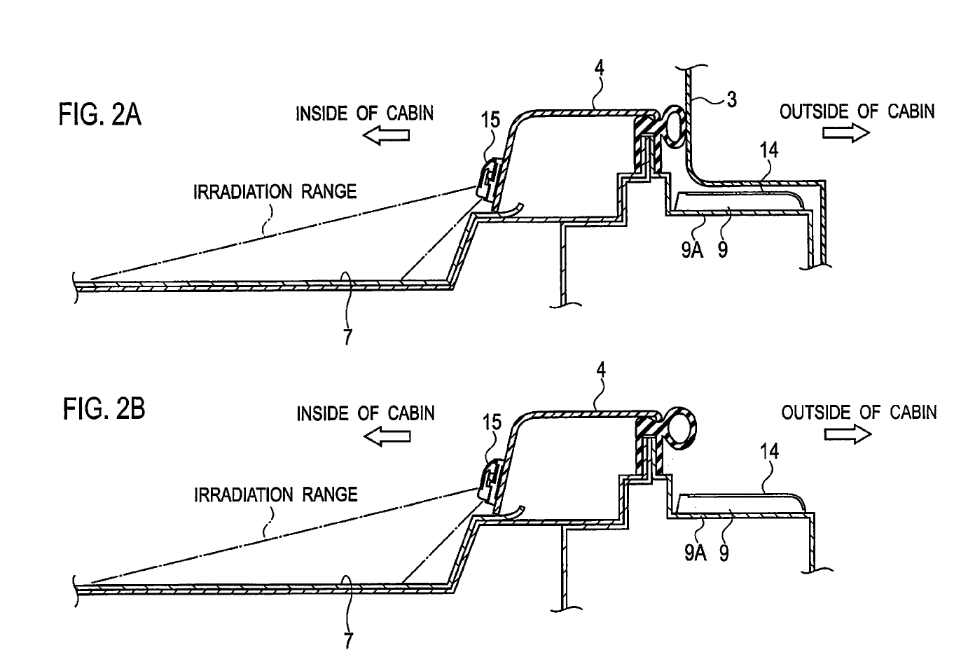

As shown in FIG. 2A and FIG. 2B, each of the inner sill lamps 15 illuminates, in a state where the door 3 is opened, the floor 7 of the cabin on which the user's feet are put when the user gets in the vehicle 2 or gets off the vehicle 2 (illuminating a range C, E, G or I in FIG. 8).

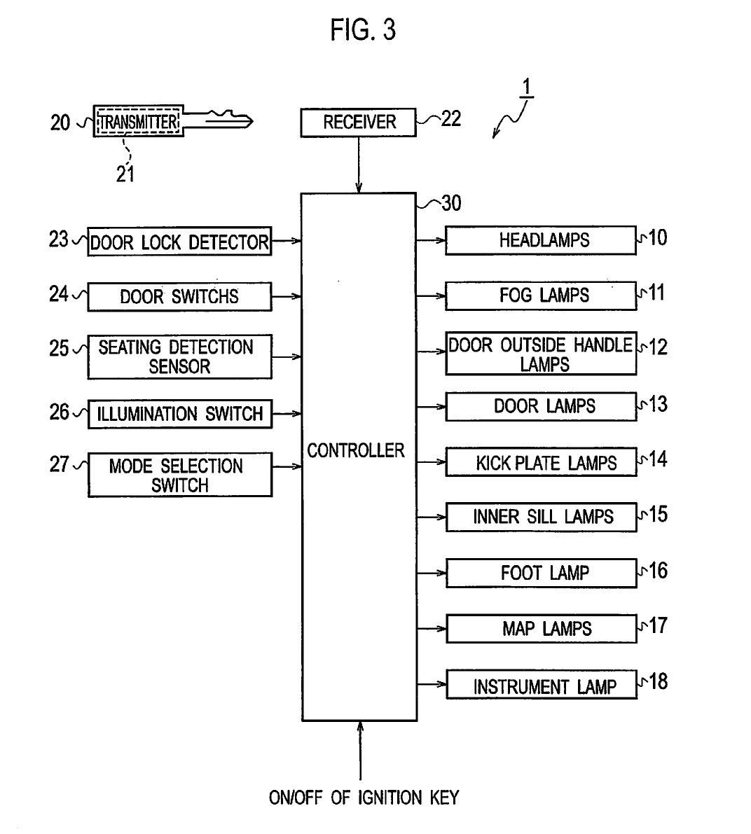

Next, a control system of the lighting device 1 is explained. As shown in FIG. 3, the lighting device 1 includes a receiver 22, a door lock detector 23, door switches (door open/close detectors) 24, a seating detection sensor 25, an illumination switch 26, and a mode selection switch 27. The receiver 22 receives a signal from a transmitter 21 in a key 20. The door lock detector 23 detects locking and unlocking of the doors 3. The door switches 24 detect opening and closing of the doors 3, respectively. The seating detection sensor 25 detects whether or not each user sits on the seat 6. By the illumination switch 26, the user can select whether or not cabin lighting is to be performed during driving the vehicle 2. By the mode selection switch 27, the user can select a cabin lighting mode during driving the vehicle 2 (an all lighting mode, a reduced lighting mode, a fluctuated lighting mode, and a flashed lighting mode). Detection signals by the above components are outputted to a controller 30. ON/OFF information on an ignition key is also outputted to the controller 30.

The controller 30 detects whether a user who has the key 20 is positioned at a close position to the vehicle 2 or a distant position from the vehicle 2 based on information from the receiver 22. Accordingly, a user position detector is constituted of the transmitter 21 in the key 20 and the receiver 22 and the controller 30 on the vehicle 2.

Based on the above-mentioned detection signals, the controller 30 controls turning on/off of the headlamps 10, the fog lamps 11, the door outside handle lamps 12, the door lamps 13, the kick plate lamps 14, the inner sill lamps 15, the foot lamp 16, the map lamp 17 and the instrument lamp 18. The controller 30 may also performs other controls. The contents of the control are explained in conjunction with following lighting operations.

Next, the lighting operations of the lighting device 1 are explained.

### (Lighting at the Time of Getting in the Vehicle)

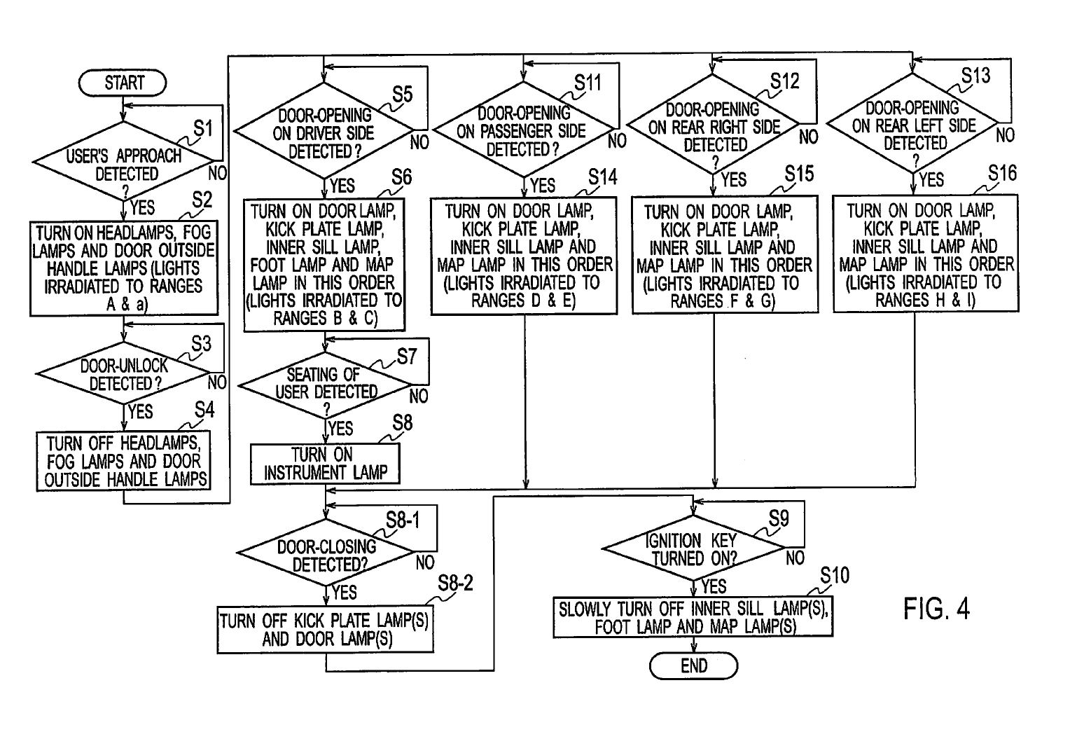

Firstly, lighting at the time of getting in the vehicle 2 is explained. As shown in FIG. 4, when a user (driver) who has the key 20 approaches the vehicle 2, the user position detector detects an approach of the user who has the key 20 (step S1). Then, the controller 30 turns on the headlamps 10 and the fog lamps 11 and, at the same time, turns on the door outside handle lamps 12 (step S2). Accordingly, as shown in FIG. 7, lights are irradiated to the ranges A by the headlamps 10 and the fog lamp 11, and lights are irradiated to the ranges a by the door outside handle lamps 12. As a result, areas around the vehicle 2 are lit up.

Next, when the user unlocks the door(s) 3, the door lock detector 23 detects such unlocking of the door(s) 3 (step S3). Then, the controller 30 turns off the headlamps 10, the fog lamps 11 and the door outside handle lamps 12 (step S4).

Next, when the user (driver) opens the door 3 of the driver's seat 6, the door switch 24 corresponding to the door 3 detects such opening of the door 3 (step S5). Then, the controller 30 turns on the door lamp 13, the kick plate lamp 14 and the inner sill lamp 15 in this order. Then, the controller 30 further turns on the foot lamp 16 and the map lamp 17 in this order (step S6). Accordingly, with respect to foot lighting for the user (driver) who is going to sit on the driver's seat 6, as shown in FIG. 8, lights are irradiated to the range B by the door lamp 13, toward an area above the kick plate 9 by the kick plate lamp 14 (not explicitly shown in FIG. 8), and to the range C by the inner sill lamp 15. Note that the foot lamp 16 also contributes the foot lighting for the user (driver).

Next, when the user (driver) sits on the driver's seat 6, the seating detection sensor 25 detects such seating (step S7). Then, the controller 30 turns on the instrument lamp 18 (step S8).

Next, when the user (driver) closes the door 3, the door switch 24 corresponding to the door 3 detects such closing of the door 3 (step S8-1). Then, the controller 30 turns off the kick plate lamp 14 and the door lamp 13 (step S8-2).

Then, when the user (driver) turns on the ignition key from an OFF state (step S9), the controller 30 slowly turns off the inner sill lamp 15, the foot lamp 16 and the map lamp 17 (step S10).

In the above-mentioned operations, when another user (other users) opens the door 3 of the passenger's seat 6, the rear right seat 6 or the rear left seat 6, the door switch 24 corresponding to the door 3 detects such opening of the door 3 (steps S11, S12, S13). Then, the controller 30 turns on the door lamp 13, the kick plate lamp 14 and the inner sill lamp 15 corresponding to the door 3 in this order. Then, the controller 30 further turns on the map lamp 17 (steps S14, S15, S16). Accordingly, with respect to foot lighting of the user who is going to sit the passenger's seat 6, as shown in FIG. 8, lights are irradiated to the range D by the door lamp 13, toward an area above the kick plate 9 by the kick plate lamp 14 (not explicitly shown in FIG. 8), and to the range E by the inner sill lamp 15. With respect to foot lighting of the user who is going to sit the rear right seat 6, as shown in FIG. 8, lights are irradiated to the range F by the door lamp 13, toward an area above the kick plate 9 by the kick plate lamp 14 (not explicitly shown in FIG. 8), and to the range G by the inner sill lamp 15. With respect to foot lighting of the user who is going to sit the rear left seat 6, as shown in FIG. 8, lights are irradiated to the range H by the door lamp 13, toward an area above the kick plate 9 by the kick plate lamp 14 (not explicitly shown in FIG. 8), and to the range I by the inner sill lamp 15. Thereafter, process flow returns to the above-mentioned step S8-1.

### (Lighting at the Time of Getting Off the Vehicle)

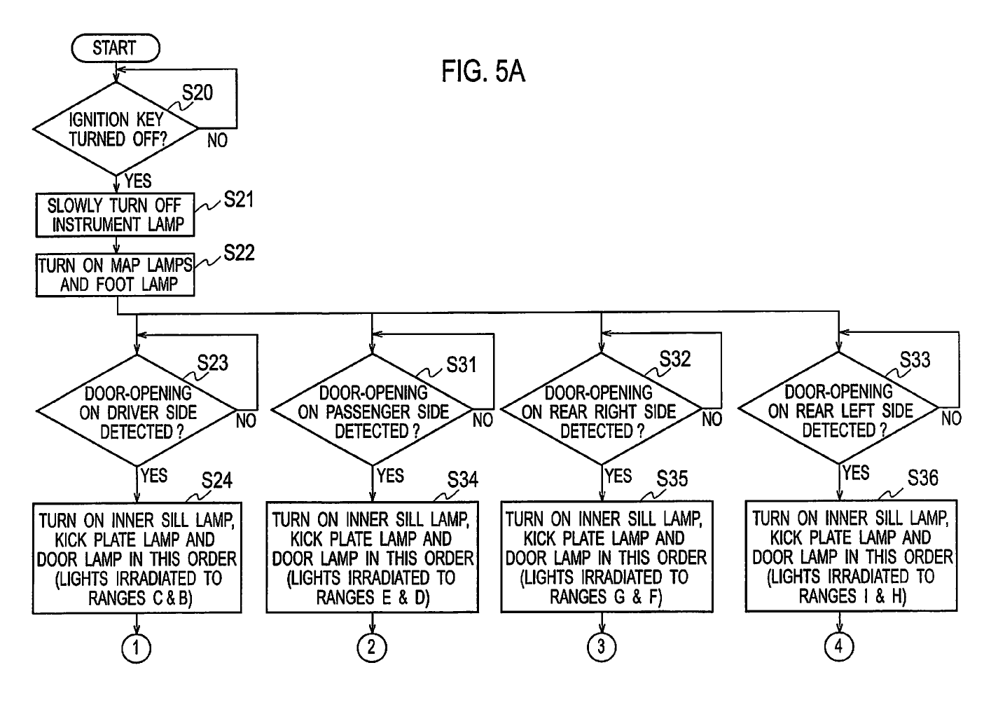

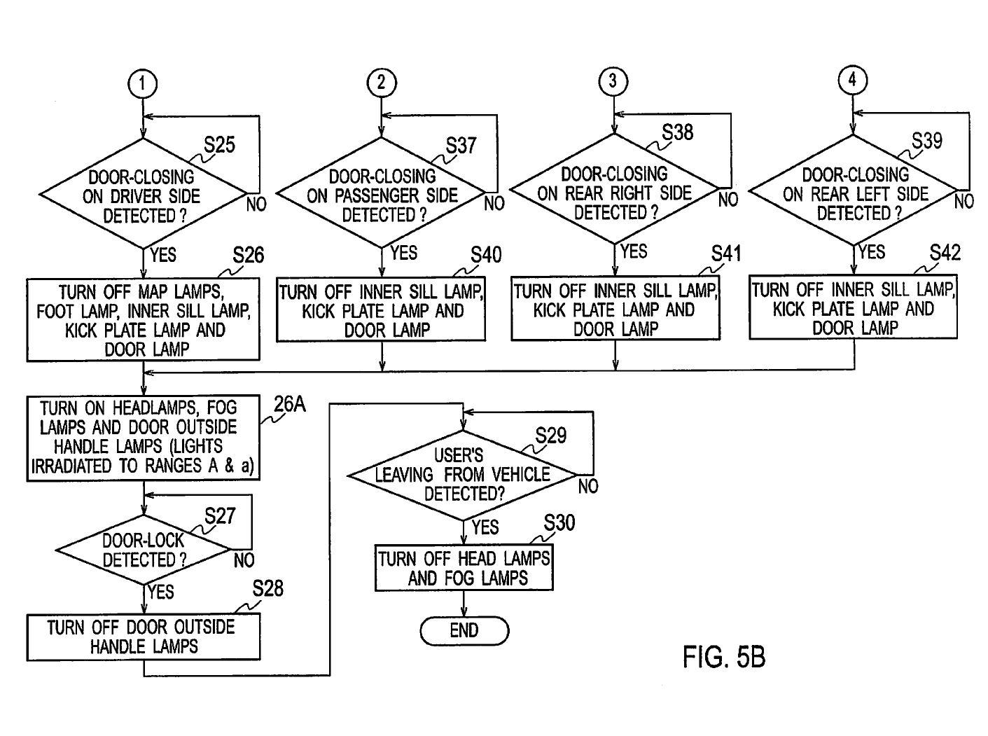

Next, lighting at the time of getting off the vehicle 2 is explained. As shown in FIG. 5A and FIG. 5B, when a user (driver) turns off the ignition key from an ON state (step S20), the controller 30 slowly turns off the instrument lamp 18 (step S21). Then, the controller 30 turns on the map lamps 17 and the foot lamp 16 (step S22).

Next, when the user (driver) opens the door 3 of the driver's seat 6, the door switch 24 corresponding to the door 3 detects such opening of the door 3 (step S23). Then, the controller 30 turns on the inner sill lamp 15, the kick plate lamp 14 and the door lamp 13 in this order (step S24). Accordingly, with respect to foot lighting of the user (driver) who gets off the driver's seat 6, as shown in FIG. 8, lights are irradiated to the range C by the inner sill lamp 15, toward an area above the kick plate 9 by the kick plate lamp 14 (not explicitly shown in FIG. 8), and to the range B by the door lamp 13.

Next, when the user (driver) gets off the vehicle and closes the door 3, the door switch 24 corresponding to the door 3 detects such closing of the door 3 (step S25). Then, the controller 30 turns off the map lamps 17, the foot lamp 16, the inner sill lamp 15, the kick plate lamp 14 and the door lamp 13 (step S26). Thereafter, the controller 30 turns on the headlamps 10, the fog lamps 11 and the door outside handle lamps 12 (step S26A). Accordingly, as shown in FIG. 7, light are irradiated to the ranges A by the headlamps 10 and the fog lamps 11 and to the ranges a by the door outside handle lamps 12. As a result, areas around the vehicle 2 are lit up.

Next, when the user locks the door 3, the door lock detector 23 detects such locking (step S27). Then, the controller 30 turns off the door outside handle lamps 12 (step S28).

When the user who has the key 20 moves away from the vehicle 2 by a predetermined distance, the user position detector detects a departure of the user who has the key 20 (step S29). Then, the controller 30 turns off the headlamps 10 and the fog lamps 11 (step S30).

In the above-mentioned operations, when another user (other users) opens the door 3 of the passenger's seat 6, the rear right seat 6 or the rear left seat 6, the door switch 24 corresponding to the door 3 detects such opening of the door 3 (steps S31, S32, S33). Then, the controller 30 turns on the inner sill lamp 15, the kick plate lamp 14 and the door lamp 13 corresponding to the door 3 in this order (steps S34, S35, S36). Accordingly, with respect to foot lighting of the user who gets off the passenger's seat 6, as shown in FIG. 8, lights are irradiated to the range E by the inner sill lamp 15, toward an area above the kick plate 9 by the kick plate lamp 14 (not explicitly shown in FIG. 8), and to the range D by the door lamp 13. With respect to foot lighting of the user who gets off the rear right seat 6, as shown in FIG. 8, lights are irradiated to the range G by the inner sill lamp 15, toward an area above the kick plate 9 by the kick plate lamp 14 (not explicitly shown in FIG. 8), and to the range F by the door lamp 13. With respect to foot lighting of the user who gets off the rear left seat 6, as shown in FIG. 8, lights are irradiated to the range I by the inner sill lamp 15, toward an area above the kick plate 9 by the kick plate lamp 14 (not explicitly shown in FIG. 8), and to the range H by the door lamp 13.

Then, when the door 3 is closed, the door switch 24 corresponding to the door 3 detects such closing of the door 3 (steps S37, S38, S39). Then, the controller 30 turns off the inner sill lamp 15, the kick plate lamp 14 and the door lamp 13 corresponding to the door 3 (steps S40, S41, S42). Thereafter, process flow returns to the above-mentioned step S26A.

### (Cabin Lighting at the Time of Driving)

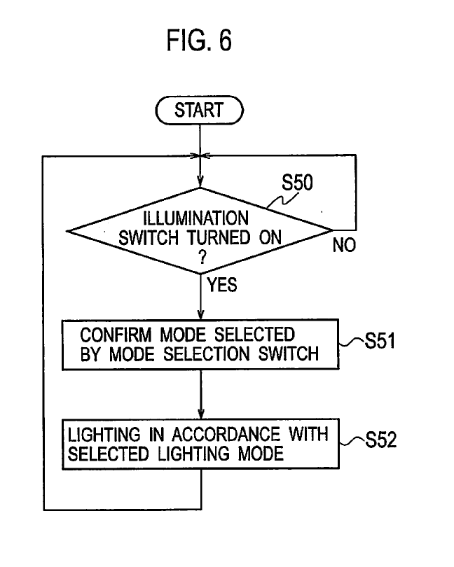

As shown in FIG. 6, the user turns on the illumination switch 26 when driving (step S50). The controller 30 confirms a lighting mode selected by the mode selection switch 27 (step S51) and turns on or flashes the above-mentioned lamps in the cabin in accordance with the selected lighting mode (step S52).

According to the lighting device 1, when the user who has the key 20 approaches the vehicle 2, the areas around the vehicle 2 are illuminated by the headlamps 10, the fog lamps 11 and the door outside handle lamps 12. When the user opens the door 3 to get in the vehicle 2, the ground on which the user stands at the time of getting in the vehicle 2 is illuminated by the door lamp 13, and then the floor 7 of the cabin into which the user gets is illuminated by the inner sill lamp 15 so that the user can be supported to get in the vehicle 2 by the lightings. Accordingly, the user can smoothly get in the vehicle 2 at night (a dark place).

Particularly, in this embodiment, since the door lamp 13, the kick plate lamp 14 and the inner sill lamps 15 are turned on in this order when the user gets in the vehicle 2, the user can be guided to get in the vehicle 2 more effectively.

In addition, the controller 30 further turns on the foot lamp 16 and the map lamp 17 after turning on the inner sill lamps 15 upon detection of the opening of the door 3 by the door switch 24. Accordingly, when the user gets in the vehicle 2, the floor 7 around the user's feet (around the pedals 8) is illuminated by the foot lamp 16 and the cabin into which the user gets is illuminated by the map lamp 17 so that the user can get in the vehicle 2 more smoothly.

In addition, the controller 30 turns off the headlamps 10, the fog lamps 11 and the door outside handle lamps 12 when the door lock detector 23 detects unlocking of the door 3. Accordingly, it is possible to suppress wasteful power consumption.

In addition, the controller 30 turns on the instrument lamp 18 when the seating detection sensor 25 detects the seating of the user. Since the instrument lamp 18 is turned on when the user (driver) sits on the seat 6, operability for the user at night can be enhanced.

In addition, the controller 30 turns off the door lamp 13, the kick plate lamp 14 and the inner sill lamps 15 when the ignition key is turned on. Since the door lamp 13, the kick plate lamp 14 and the inner sill lamps 15 are turned off when the user turns on the ignition key, it is possible to suppress wasteful power consumption.

According to the lighting device 1, when the user opens the door 3 to get off the vehicle 2, the floor 7 on which the user's feet are put is illuminated by the inner sill lamp 15 until the user gets off the vehicle 2, and then the ground on which the user's feet put is illuminated by the door lamp 13 when the user gets off the vehicle 2. In addition, the areas around the vehicle 2 are illuminated by the headlamps 10, the fog lamps 11 and the door outside handle lamps 12 when the user closes the door 3 so that the user can be supported to get off the vehicle 2 by the lightings. Accordingly, the user can smoothly get off the vehicle 2 at night (a dark place).

Particularly, in this embodiment, since the inner sill lamps 15, the kick plate lamps 14 and the door lamps 13 are turned on in this order when the user gets off the vehicle 2, the user can be guided to get off the vehicle 2 more effectively.

In addition, the controller 30 turns off the instrument lamp 18, and then turns on the map lamps 17 and the foot lamp 16. Accordingly, it is possible to suppress wasteful power consumption.

In addition, the controller 30 turns off the door outside handle lamps 12 upon detection of locking of the door 3 by the door lock detector 23, and then turns off the headlamps 10 and the fog lamps 11 upon detection of the user's departure from the vehicle 2 by the user position detector. Namely, the door outside handle lamps 12 are turned off when the user who has got off the vehicle 2 locks the door 3, and then the headlamps 10 and the fog lamps 11 are turned off when the user leaves the vehicle 2. Accordingly, it is possible to suppress wasteful power consumption.

With respect to a control of the vehicle exterior lamp, turning on/off of the headlamps 10, the fog lamps 11 and the door outside handle lamps 12 are all controlled. However, turning on/off of on only the headlamps 10 and the door outside handle lamps 12 may be controlled with excluding the fog lamps 11 from the control.

The floor lamp is constituted of the inner sill lamps 15 provided on the inner sill covers 4 near the floor 7 around the user's feet at the time of getting in or off the vehicle 2. Accordingly, it is possible to surely illuminate the floor 7 around the user's feet at the time of getting in or off the vehicle 2 with sufficient brightness. Since the inner sill lamps 15 are provided on the inner sill covers 4 near the floor 7, lights from the inner sill lamps 15 is not obscured by the instrument panel 5 or the seats 6 and surely illuminate the floor 7. Further, the inner sill cover 4 is mounted in a raised manner at a position closest to a floor position on which the user's feet are put when the user gets in or off the vehicle 2. Accordingly, it is possible to surely illuminate the floor 7 around the user's feet at the time of getting in or off the vehicle 2.

### (Other Technical Features)

In this embodiment, the controller 30 turns off the inner sill lamps 15 when the user turns on the ignition key from an OFF state at the time of getting in the vehicle 2. However, the inner sill lamp (s) 15 may be turned off when the door switch (s) 24 detects closing of the door(s) 3.

In this embodiment, the vehicle exterior lamp is constituted of the headlamp 10, the fog lamp 11 and the door outside handle lamp 12. However, the vehicle exterior lamp may be constituted of one of these lamps or two arbitrarily selected from these lamps. Needless to say, any lamp that can illuminate the outside of the vehicle 2 may be used as the vehicle exterior lamp. A clearance lamp, a tail lamp or the like may constitute the vehicle exterior lamp.

Note that various kinds of lamps may be used as the above-mentioned lamps. For example, a halogen lamp, a projector lamp or a discharge lamp can be appropriately used as the headlamp 10 or the fog lamp 11. An LED lamp, a filament lamp, a fluorescent lamp or the like may also be used as the above-mentioned lamps.

In this embodiment, the ground lamp is constituted of the door lamp 13. However, any lamp that can illuminate the ground on which a user stands at the time of getting in or off the vehicle 2 when the door 3 is opened may be used as the ground lamp.

In this embodiment, the floor lamp is constituted of the inner sill lamp 15. However, any lamp that can illuminate the floor 7 of the cabin on which the user's feet are put at the time of getting in or off the vehicle 2.

Further, the vehicle cabin lighting at the time of driving may be varied in accordance with time, music in the cabin, temperature in a cabin and the like. For example, the lighting mode may be differed depending on time (morning, afternoon, night, midnight), music in the cabin or temperature in the cabin.

Although the invention has been described above by reference to a certain embodiment of the invention, the invention is not limited to the embodiment described above. Modifications and variations of the embodiment will occur to those skilled in the art, in light of the above teachings. The scope of the invention is defined with reference to following claims.

What is claimed is:

1. A lighting device for a vehicle, comprising:
a vehicle exterior lamp that illuminates an outside of the vehicle;
a ground lamp that illuminates a ground on which a user stands when the user is going to open a door to get on the vehicle;
a floor lamp that illuminates a cabin floor on which a user's foot is to be put when a user is going to get in the vehicle;
a user position detector that detects whether the user is at a close position to the vehicle or a distant position from the vehicle;
a door open/close detector that detects opening and closing of the door; and
a controller that
turns on the vehicle exterior lamp when the user position detector detects a user's approach to the vehicle,
turns on the ground lamp when opening of the door is detected by the door open/close detector, and then
turns on the floor lamp.

2. The lighting device according to claim 1, wherein
the controller further turns on a foot lamp and a map lamp after turning on the floor lamp.

3. The lighting device according to claim 1, further comprising
a door lock detector that detects locking and unlocking of the door, wherein
the controller turns off the vehicle exterior lamp when the door lock detector detects unlocking of the door.

4. The lighting device according to claim 1, further comprising
an instrument lamp that illuminates a meter; and
a seating detector that detects seating of the user, wherein
the controller turns on the instrument lamp when the seating detector detects seating of a driver.

5. The lighting device according to claim 1, wherein
the controller turns off the ground lamp and the floor lamp when an ignition key is turned on.

6. A lighting device for a vehicle, comprising:
a floor lamp that illuminates a cabin floor on which a user's foot is to be put when a user is going to get off the vehicle;
a ground lamp that illuminates a ground on which the user is going to stand when the user opens a door to get off the vehicle;
a vehicle exterior lamp that illuminates an outside of the vehicle;
a door open/close detector that detects opening and closing of the door; and
a controller that
sequentially turns on the floor lamp and the ground lamp when the door open/close detector detects opening of the door, and then
turns on the vehicle exterior lamp.

7. The lighting device according to claim 6, further comprising
an instrument lamp that illuminates a meter, wherein
the controller turns off the instrument lamp when an ignition key is turned off, and then turns on a foot lamp and a map lamp.

8. The lighting device according to claim 6, further comprising
a user position detector that detects whether the user is at a close position to the vehicle or a distant position from the vehicle; and
a door lock detector that detects locking and unlocking of the door, wherein
the vehicle exterior lamp includes a headlamp and an door outside handle lamp, and
the controller turns off the door outside handle lamp when the door lock detector detects locking of the door, and turns off the headlamp when the user position detector detects a user's departure from the vehicle.
